(19) United States
(12) Patent Application Publication
(10) Pub. No.: US 2022/0104438 A1
(43) Pub. Date: Apr. 7, 2022

(54) TENT CONFIGURATION

(71) Applicant: 118 GROW CONCEPTS, INC., Chatsworth, CA (US)

(72) Inventor: Adam Wolf, Chatsworth, CA (US)

(21) Appl. No.: 17/062,688

(22) Filed: Oct. 5, 2020

(51) Int. Cl. A01G 13/02; A01G 13/04

(52) U.S. Cl. CPC A01G 13/0206; A01G 13/04

(57) ABSTRACT

A tent configuration having a base unit, a plurality of wall panels removably attached to the base unit and a roof panel removably attached to the base unit. The wall panels and roof panel include a layer of insulation.

### BACKGROUND OF THE INVENTION

### 1. Field of the Invention

The present invention relates to &n insulated tent configuration having removable panels using T channel framing and particularly adapted to grow plants indoors.

### 2. Description of the Prior Art

Many people use grow tents to grow different types of plants indoors for both hobby and commercial use. Grow tents, in conjunction with standard equipment such as exhaust fans and grow lights, allow the user to control some variables to a certain degree which contribute to better results, these variables include temperature, humidity, both day and night cycles, and shielding from potential pest issues. Traditional grow tents are made up of materials mat are very thin and offer little to no isolation allowing the interior of the tent to acquire conditions of the room where the tent is placed. There remains a need in the construction of grow tents for insulation which can increase the user's ability to create a more ideal interior notwithstanding conditions outside the tent. In addition, the panels used in prior ad tents do not have the capability of being replaced.

What is desired is to provide a tent that overcomes the disadvantages noted above which can be used in many environments including as a grow tent.

### SUMMARY OF THE INVENTION

The present invention provides a tent particularly adapted to grow different types of plants indoors. Specifically, the tent incorporates internal or external insulation to create conditions that enable plants to grow in optimum conditions regardless of conditions outside me tent. The tent uses removable panels for the tent roof and insulation material that adheres to tent walls. T channel framing is preferably used in the tent configuration.

### DESCRIPTION OF THE DRAWINGS

For a belter understanding of the present invention as well as other objects and further features thereof, reference is made to the following description which is to be read in conjunction with the accompanying drawings wherein:

FIG. 1 is an exterior perspective view of tent that incorporates the teachings of the present invention;

FIG. 2 is an exploded view of the tent of the present invention;

FIG. 3 is a perspective view of the tent of FIG. 1 with three panels removed;

FIG. 4 illustrates two tents of the present invention coupled together;

FIG. 5 is a perspective view illustrating the relative sizes of a wall panel and a roof panel;

FIG. 6 is a perspective view showing the hoop and loop material m more detail; and

FIG. 7 is an exploded view illustrating how insulation maybe incorporated into the wall and roof panels.

### DESCRIPTION OF THE INVENTION

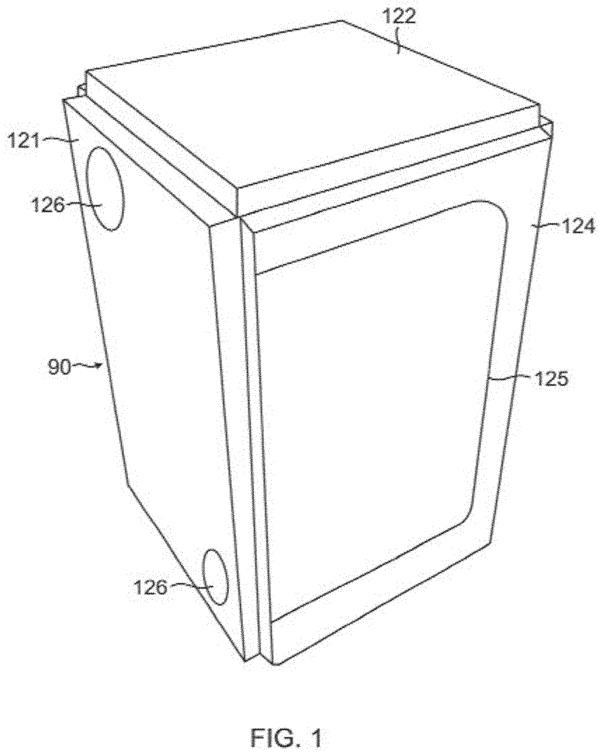

FIG. 1 illustrates tent 90 which incorporates base unit 100 (FIG. 3) of the present invention. Base unit 100 preferably measures 4′ wide, 4′ in depth with a height of 7′ and consists of a frame constructed of extruded aluminum T channel brackets 111 which offer many possibilities in mounting equipment such as exhaust fans, lights, Wi-Fi cameras, and other equipment that would be useful to an individual inside the tent enclosure such as growing plants. Surrounding the frame is a double layer material 110 (commonly used in standard grow tent construction) consisting of woven nylon canvas on the outside and diamond reflective material on the inside. The canvas material allows far a rugged and long lasting exterior with blackout properties which are required for plants during the dark period. The reflective material helps maximize the amount of light that hits leaves on a plant at as many angles as possible, optimizing growth and energy costs to run a grow tight. The double layer material fully encloses throe sides—the floor and two walls—wall, or panel, 124 having a zip up door 125. On the other three sides (two walls and the roof) the material has a cut out with hook and loop material on the outside for easy expansion with other base units or panels (FIG. 4). Rounded, reinforced corners 112 provide stronger and long-lasting seams. Hook and loop fastener material (such as that said under the Velcro brand) on the roof panel 122 will be adhered to and cover most of the outer canvas (on the three open sides) to allow for attachment of various panels or other base units. The hook and loop fastener system comprises a hook material and a loop material. Two of the 4′×7′ sides will have the hook material, the other two of them having the loop material, and roof panel 122 has either hook or loop material. The bottom, or floor, 114 base unit 100 is closed off with the same double layer tent material as noted hereinabove.

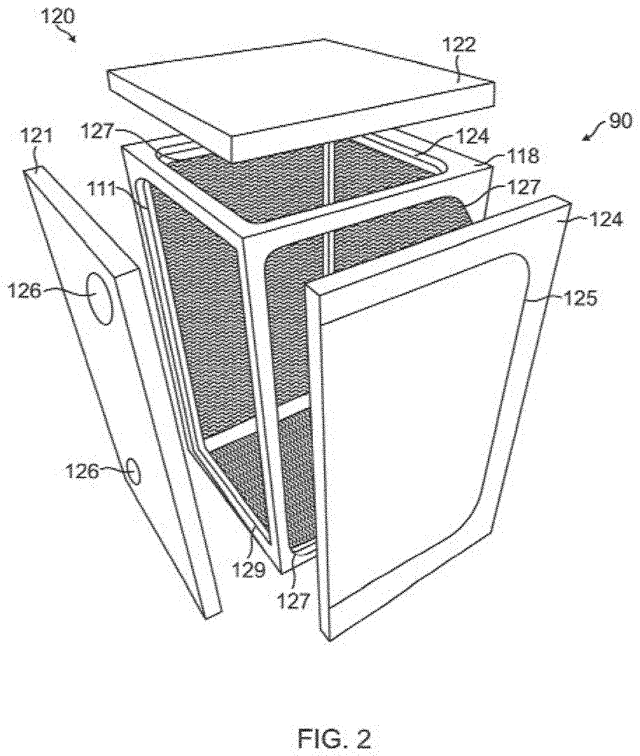

FIG. 2 is an exploded view of tent 90 with four panels attached thereto. In particular, wall panel 124 is constructed of black out canvases and measures 4′×7′×3.5′ and has insulation on its inside surface. The insulation is installed at the production facility and the user will not be exposed, nor have to deal with potential hazards of working with insulation. Two double sided cinch ports 126 at diagonally opposing top and bottom corners are provided to allow for ducting, electrical and any other necessary things to penetrate the panel while the enclosure is otherwise closed. Cinch ports allow the user to make a tight seal both inside and outside around items like ducting to ensure no light leaks in or out, temperature and humidity inside the enclosure remains isolated and manageable, as well as limiting entry tor unwanted insects such as spiders mites, aphids, etc. The panel sides that contact base unit 100 have hook or loop materials for attaching to the base unit as well as reflective materials 127. Roof panel 122 is constructed of black out canvases and measures 4′×4′×3.5″, the inside surface having insulation material adhering thereto. The roof panel 122 has hook or loop material for attaching to the base unit 100 as well as reflective material 127 (other attachment systems can be used, such as zippers, the only being that the bond between base unit 100 and the panel used is a light proof seal). Roof panel 122 can be replaced with other panels to increase the height of the tent (this allows the end user can grow taller plants, tor example, without being too close to the lights that typically are positioned above the plants) or tor other purposes and, as noted above, has hook or loop material for attaching it to base unit 100. The preferred roof panel is a flat member Door panel 125 is constructed of blackout canvas and measures at 4′×7′×3.5″ and has 3.5″ thick insulation inside. A heavy-duty zipper on door wall 125 provides access to the inside of the tent enclosure. Similar to wall panel 124, door panel 125 has reflective material 127 and a book or loop material on the side that comes info contact with base unit 100.

FIG. 3 is a perspective view of base unit 100 with wall, door, and roof panels removed and FIG. 4 shows two identical base units 100 attached together to form a larger tent footprint. The common panel separating the units can be removed to form an integrated base unit with an extended enclosure area.

FIG. 5 is a view of a typical wall panel 124 and roof panel 122. Reference numeral 127 identifies material (same material used in the base unit 100) that is pasted on the wall panel 124 with its reflective side facing outward, the side shown in the figure facing the inside of base unit 100. Reference numeral 140 identifies the hook and loop material that attaches to the outside perimeter of the base unit 100 which enables all the wall panels to be attached to the base unit 100.

FIG. 6 illustrates hook and loop material 140 installed on the outside frame of base unit 100 to mate with the corresponding hook and loop materiel on the wall and roof panels.

FIG. 7 is an exploded view illustrating how the insulation is installed into the wall and roof panels. Reference numeral 130 identifies the exterior nylon canvas fabric portion of the wall panel; reference numeral 131 identifies the wall panel batting; reference numeral 132 illustrates the bottom portion of the wall panel and attached to the base unit 100; reference numeral 135 is the exterior nylon canvas fabric for the roof panel; reference numeral 134 identifies the roof panel batting; reference numeral 133 identifies the portion of the roof panel made of nylon canvas and shown attached to base unit 100 and reference numeral 124 shows a wall panel secured to base unit 100.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A tent configuration comprising:
A first base unit having sides adapted to each receive a wall panel and an area to receive a roof panel;
a plurality of wall panels secured to the sides of said base unit, said wall panels having a layer of insulation;
a roof panel attached to said base unit area, said roof panel having a layer of insulation; and;
a system for connecting said wall panels and said roof panel to said case unit.

2. The tent configuration of claim 1 wherein said roof panel is removable.

3. The tent configuration of claim 1 wherein one of said wall panels has an entrance flap which can be opened or closed.

4. The tent configuration of claim 1 including a second base unit which is similar to said first base unit, said first base urns being positioned adjacent to said first base unit.

5. The tent configuration of claim 1 wherein each of said wall panels comprise a plurality of layers, one of said layers being formed of insulating material.

6. The tent configuration of claim 5 wherein said roof panel composes a plurality of layers, one of said layers being formed of insulating material.
